(19) United States
(12) Patent Application Publication
(10) Pub. No.: US 2026/0025255 A1
(43) Pub. Date: Jan. 22, 2026

(54) POWER CONTROL PARAMETER CONFIGURATION FOR FULL DUPLEX SYMBOLS IN A UNIFIED TRANSMISSION CONFIGURATION INDICATOR FRAMEWORK

(71) Applicant: QUALCOMM Incorporated, San Diego, CA (US)

(72) Inventors: Muhammad Sayed Khairy ABDELGHAFFAR, San Jose, CA (US); Qian ZHANG, Basking Ridge, NJ (US); Yan ZHOU, San Diego, CA (US)

(21) Appl. No.: 18/777,314

(22) Filed: Jul. 18, 2024

(51) Int. Cl. H04L 5/00; H04L 5/14

(52) U.S. Cl. CPC H04L 5/0096; H04L 5/14

(57) ABSTRACT

Methods, systems, and devices for wireless communications are described. A user equipment (UE) may receive control information that indicates a set of transmission configuration indicator (TCI) states, where a first TCI state of the set of TCI states is associated with a first set of power control (PC) parameters and a second set of PC parameters. The UE may receive an indication of a duplex type for one or more symbols including uplink resources, where the one or more symbols are associated with the first TCI state. As such, the UE may transmit an uplink message during the one or more symbols according to the first TCI state. For example, the UE may transmit the uplink message according to the second set of PC parameters based on the duplex type being full duplex and the first TCI state being associated with the second set of PC parameters.

### FIELD OF TECHNOLOGY

The following relates to wireless communications, including power control (PC) parameter configuration for full duplex symbols in a unified transmission configuration indicator (TCI) framework.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving control information that indicates a set of transmission configuration indicator (TCI) states, where a first TCI state of the set of TCI states is configured with a first set of power control (PC) parameters associated with uplink transmission in non-full duplex symbols and a second set of PC parameters associated with uplink transmission in full duplex symbols, receiving an indication of a duplex type for one or more TCI states of the set of TCI states; and, and transmitting an uplink message according to the first TCI state, where the uplink message is transmitted according to the second set of PC parameters based on the duplex type of the first TCI state being full duplex.

A UE for wireless communications is described. The UE may include one or more memories storing processor executable code, and one or more processors coupled with the one or more memories. The one or more processors may individually or collectively be operable to execute the code to cause the UE to receive control information that indicates a set of TCI states, where a first TCI state of the set of TCI states is configured with a first set of PC parameters associated with uplink transmission in non-full duplex symbols and a second set of PC parameters associated with uplink transmission in full duplex symbols, receive an indication of a duplex type for one or more TCI states of the set of TCI states; and, and transmit an uplink message according to the first TCI state, where the uplink message is transmitted according to the second set of PC parameters based on the duplex type of the first TCI state being full duplex.

Another UE for wireless communications is described. The UE may include means for receiving control information that indicates a set of TCI states, where a first TCI state of the set of TCI states is configured with a first set of PC parameters associated with uplink transmission in non-full duplex symbols and a second set of PC parameters associated with uplink transmission in full duplex symbols, means for receiving an indication of a duplex type for one or more TCI states of the set of TCI states; and, and means for transmitting an uplink message according to the first TCI state, where the uplink message is transmitted according to the second set of PC parameters based on the duplex type of the first TCI state being full duplex.

A non-transitory computer-readable medium storing code for wireless communications is described. The code may include instructions executable by one or more processors to receive control information that indicates a set of TCI states, where a first TCI state of the set of TCI states is configured with a first set of PC parameters associated with uplink transmission in non-full duplex symbols and a second set of PC parameters associated with uplink transmission in full duplex symbols, receive an indication of a duplex type for one or more TCI states of the set of TCI states; and, and transmit an uplink message according to the first TCI state, where the uplink message is transmitted according to the second set of PC parameters based on the duplex type of the first TCI state being full duplex.

Some examples of the method, UEs, and non-transitory computer-readable medium described herein may further include operations, features, means, or instructions for receiving, as part of the control information, a first indication that the first TCI state may be further configured with a first pathloss reference signal for pathloss measurements associated with non-full duplex symbols and a second pathloss reference signal for pathloss measurements associated with full duplex symbols.

In some examples of the method, UEs, and non-transitory computer-readable medium described herein, receiving the indication of the duplex type may include operations, features, means, or instructions for receiving, as part of a control message, a first indication for the UE to use the first TCI state for uplink messages scheduled during full duplex symbols, where transmitting the uplink message during one or more symbols according to the second set of PC parameters of the first TCI state may be based on the duplex type of the one or more symbols being full duplex.

In some examples of the method, UEs, and non-transitory computer-readable medium described herein, the set of TCI states includes a second TCI state configured with at least a third set of PC parameters associated with uplink transmission in non-full duplex symbols and the method, apparatuses, and non-transitory computer-readable medium may include further operations, features, means, or instructions for receiving, as part of the control message, a second indication for the UE to use the second TCI state for uplink messages scheduled during non-full duplex symbols and transmitting a second uplink message during one or more second symbols according to the second TCI state, where the second uplink message may be transmitted according to the third set of PC parameters based on the one or more second symbols being non-full duplex.

In some examples of the method, UEs, and non-transitory computer-readable medium described herein, the control message may be a medium access control-control element (MAC-CE) command including a bitfield that indicates that the first TCI state may be associated with full duplex symbols.

In some examples of the method, UEs, and non-transitory computer-readable medium described herein, the control message may be a downlink control information (DCI) message including a duplex field indicator that indicates that the first TCI state may be associated with full duplex symbols.

In some examples of the method, UEs, and non-transitory computer-readable medium described herein, the set of TCI states includes a third TCI state configured with a fourth set of PC parameters associated with uplink transmission in non-full duplex symbols and a fifth set of PC parameters associated with uplink transmission in full duplex symbols and the method, apparatuses, and non-transitory computer-readable medium may include further operations, features, means, or instructions for receiving, as part of the indication of the duplex type for the one or more TCI states of the set of TCI states, that the third TCI state may be associated with both full-duplex symbols and non-full-duplex symbols, transmitting a second uplink message during one or more non-full duplex symbols according to the third TCI state, where the second uplink message may be transmitted according to the fourth set of PC parameters based on the second uplink message being scheduled during the one or more non-full duplex symbols, and transmitting a third uplink message during one or more full duplex symbols according to the third TCI state, where the third uplink message may be transmitted according to the fifth set of PC parameters based on the second uplink message being scheduled during the one or more full duplex symbols.

In some examples of the method, UEs, and non-transitory computer-readable medium described herein, the first set of PC parameters include a respective first closed-loop power index and a respective first set of open-loop parameters for each of a set of sounding reference signals and uplink channels and the second set of PC parameters include the respective first closed-loop power index and a respective second set of open-loop parameters that may be different than the respective first set of open-loop parameters for each of the set of sounding reference signals and uplink channels.

In some examples of the method, UEs, and non-transitory computer-readable medium described herein, each respective second set of open-loop parameters includes a set of power offset values relative to a corresponding respective first set of open-loop parameters.

In some examples of the method, UEs, and non-transitory computer-readable medium described herein, the first set of PC parameters include a respective first set of open-loop parameters and a respective first closed-loop power index for each of a set of sounding reference signals and uplink channels and the second set of PC parameters include the respective first set of open-loop parameters and a respective second closed-loop power index that may be different than the respective first closed-loop power index for each of the set of sounding reference signals and uplink channels.

Some examples of the method, UEs, and non-transitory computer-readable medium described herein may further include operations, features, means, or instructions for receiving a configuration of a first default set of PC parameters associated with uplink transmission in non-full duplex symbols and a second default set of PC parameters associated with uplink transmission in full duplex symbols, receiving, as part of the indication of the duplex type for the one or more TCI states of the set of TCI states, an indication that that a fourth TCI state may be associated with full duplex symbols, where the fourth TCI state may be not configured with any set of PC parameters, and transmitting a second uplink message according to a fourth TCI state, where the second uplink message may be transmitted according to the second default set of PC parameters based on the duplex type of the fourth TCI state being full duplex and the fourth TCI state not being configured with any set of PC parameters.

Some examples of the method, UEs, and non-transitory computer-readable medium described herein may further include operations, features, means, or instructions for transmitting a capability message that indicates that the UE supports multiple PC parameter sets associated with different symbol duplex types for a single TCI state, where receiving the control information may be based on transmitting the capability message.

In some examples of the method, UEs, and non-transitory computer-readable medium described herein, the set of TCI states includes a set of joint uplink and downlink TCI states or a set of uplink-only TCI states.

In some examples of the method, UEs, and non-transitory computer-readable medium described herein, a second TCI state of the set of TCI states may be associated with a single set of PC parameters for uplink transmissions by the UE during non-duplex symbols and during full duplex symbols.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports power control (PC) parameter configuration for full duplex symbols in a unified transmission configuration indicator (TCI) framework in accordance with one or more aspects of the present disclosure.

FIG. 2 shows an example of a network architecture that supports PC parameter configuration for full duplex symbols in a unified TCI framework in accordance with one or more aspects of the present disclosure.

FIG. 3 shows an example of a wireless communications system that supports PC parameter configuration for full duplex symbols in a unified TCI framework in accordance with one or more aspects of the present disclosure.

FIGS. 4A and 4B each show an example of a multi-PC transmission timeline that supports PC parameter configuration for full duplex symbols in a unified TCI framework in accordance with one or more aspects of the present disclosure.

FIG. 5 shows an example of a process flow that supports PC parameter configuration for full duplex symbols in a unified TCI framework in accordance with one or more aspects of the present disclosure.

FIGS. 6 and 7 show block diagrams of devices that support PC parameter configuration for full duplex symbols in a unified TCI framework in accordance with one or more aspects of the present disclosure.

FIG. 8 shows a block diagram of a communications manager that supports PC parameter configuration for full duplex symbols in a unified TCI framework in accordance with one or more aspects of the present disclosure.

FIG. 9 shows a diagram of a system including a device that supports PC parameter configuration for full duplex symbols in a unified TCI framework in accordance with one or more aspects of the present disclosure.

FIGS. 10 and 11 show flowcharts illustrating methods that support PC parameter configuration for full duplex symbols in a unified TCI framework in accordance with one or more aspects of the present disclosure.

### DETAILED DESCRIPTION

In some examples of wireless communications, a user equipment (UE) may transmit to a network entity one or more uplink messages (e.g., physical uplink shared channel (PUSCH) transmission, physical uplink control channel (PUCCH) transmission, a sounding reference signal (SRS) transmission). Additionally, or alternatively, the UE may transmit a given uplink message in accordance with a set of power control (PC) parameters, which manage transmission power of the given uplink message to maintain signal quality and reduce interference. For instance, the UE may be configured with a set of transmission configuration indicator (TCI) states, where each TCI state is associated with a respective set of PC parameters. As such, if a first TCI state is activated at the UE, then the UE may use the associated PC parameters to transmit uplink messages. In some cases, however, the UE may support uplink transmissions during both non-duplex symbols (e.g., non-subband full duplex (SBFD)) and during full duplex symbols (e.g., SBFD). Additionally, SBFD symbols may be associated with additional interference compared to non-SBFD symbols (e.g., static or predicted self-interference at the network entity and random variable interference due to inter-network entity cross link interference (CLI)). As such, it may be advantageous for the UE to be associated with respective PC parameters for transmission during non-SBFD symbols and SBFD symbols.

The UE may increase signal quality for uplink transmissions during non-SBFD symbols and SBFD symbols by operating in accordance with multiple set of PC parameters for a given TCI state. For example, a network entity may transmit to the UE control information that configures the UE with a set of TCI states, where each TCI state may be configured with up to two sets of PC parameters. For instance, a first TCI state may be configured with a first set of PC parameters for non-SBFD communications and a second set of PC parameters for SBFD communications. Additionally, or alternatively the UE may determine which TCI state and which PC parameters of the TCI state to use for a given uplink transmission. In a first example, the network entity may transmit an explicit indication that indicates to use a first TCI state during non-SBFD symbols and a second TCI state during SBFD symbols. For example, if both the first TCI state and the second TCI state are configured with two sets of PC parameters, the UE may use the first TCI state and the associated non-SBFD PC parameters during non-SBFD symbols and use the second TCI state and the associated SBFD PC parameters during SBFD symbols. In a second example, the UE may determine to use a single TCI state for both SBFD and non-SBFD symbols, where the UE may use the first set of PC parameters of the single TCI state for non-SBFD symbols and a second set of PC parameters of the single TCI state for SBFD symbols. In some examples, the network entity may configure one or more default PC parameters at the UE to use for non-SBFD symbols, SBFD symbols, or both. For example, if a TCI state (e.g., activated TCI state) is not configured with PC parameters, the UE may use the default PC parameters for transmission of an uplink message during non-SBFD symbols, during SBFD symbols, or both.

Aspects of the disclosure are initially described in the context of wireless communications systems, network architecture, multi-PC transmission timelines, and a process flow. Aspects of the disclosure are further illustrated by and described with reference to apparatus diagrams, system diagrams, and flowcharts that relate to PC parameter configuration for full duplex symbols in a unified TCI framework.

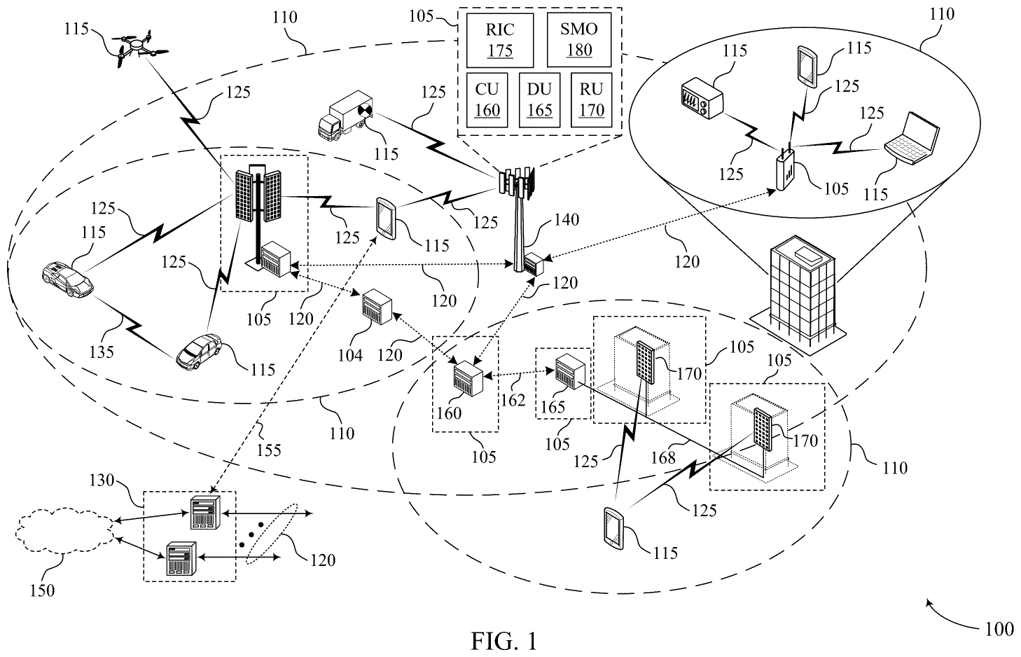

FIG. 1 shows an example of a wireless communications system 100 that supports PC parameter configuration for full duplex symbols in a unified TCI framework in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples of wireless communications system 100, a UE 115 may transmit to a network entity 105 one or more uplink messages (e.g., PUSCH transmission, PUCCH transmission, an SRS transmission). Additionally, or alternatively, the UE 115 may transmit a given uplink message in accordance with a set of PC parameters, which manage transmission power of the given uplink message to maintain signal quality and reduce interference. For instance, the UE 115 may be configured with a set of TCI states, where each TCI state is associated with a respective set of PC parameters. As such, if a first TCI state is activated at the UE 115, then the UE 115 may use the associated PC parameters to transmit uplink messages. In some cases, however, the UE 115 may support uplink transmissions during both non-duplex symbols (e.g., non-SBFD) and during full duplex symbols (e.g., SBFD). Additionally, SBFD symbols may be associated with additional interference compared to non-SBFD symbols (e.g., static or predicted self-interference at the UE 115 and random variable interference due to inter-network entity 105 CLI). As such, it may be advantageous for the UE 115 to be associated with respective PC parameters for transmission during non-SBFD symbols and SBFD symbols.

The UE 115 may increase signal quality for uplink transmissions during non-SBFD symbols and SBFD symbols by operating in accordance with multiple set of PC parameters for a given TCI state. For example, a network entity 105 may transmit to the UE 115 control information that configures the UE 115 with a set of TCI states, where each TCI state may be configured with up to two sets of PC parameters. For instance, a first TCI state may be configured with a first set of PC parameters for non-SBFD communications and a second set of PC parameters for SBFD communications. Additionally, or alternatively the UE 115 may determine which TCI state and which PC parameters of the TCI state to use for a given uplink transmission. In a first example, the network entity 105 may transmit an explicit indication that indicates to use a first TCI state during non-SBFD symbols and a second TCI state during SBFD symbols. For example, if both the first TCI state and the second TCI state are configured with two sets of PC parameters, the UE 115 may use the first TCI state and the associated non-SBFD PC parameters during non-SBFD symbols and use the second TCI state and the associated SBFD PC parameters during SBFD symbols. In a second example, the UE 115 may determine to use a single TCI state for both SBFD and non-SBFD symbols, where the UE 115 may use the first set of PC parameters of the single TCI state for non-SBFD symbols and a second set of PC parameters of the single TCI state for SBFD symbols. In some examples, the network entity 105 may configure one or more default PC parameters at the UE 115 to use for non-SBFD symbols, SBFD symbols, or both. For example, if a TCI state activated at the UE 115 is not configured with PC parameters, the UE 115 may use the default PC parameters for transmission of an uplink message during non-SBFD symbols, during SBFD symbols, or both.

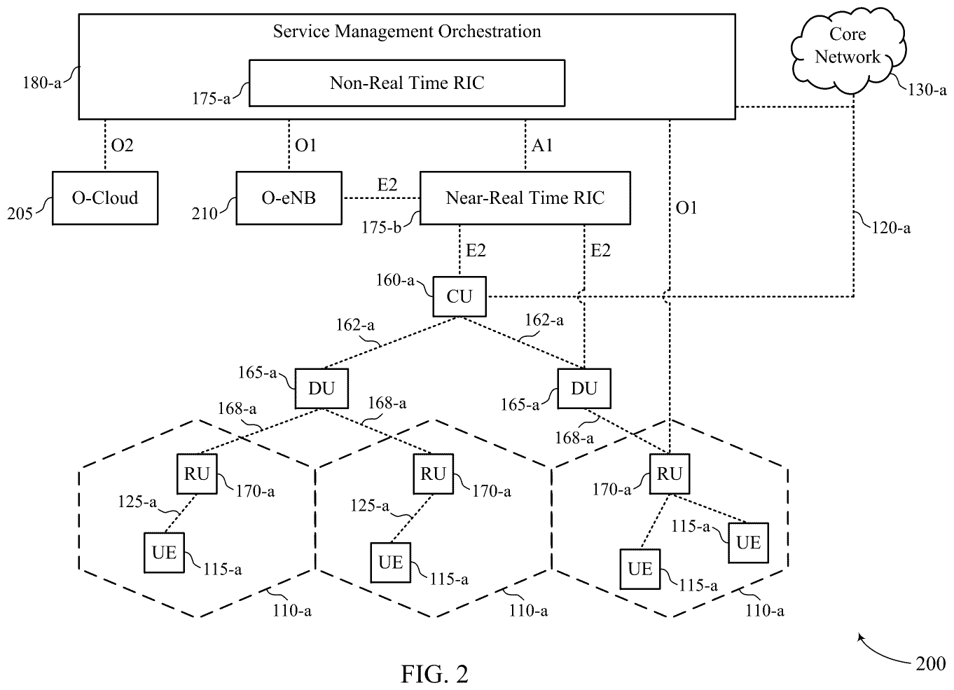

FIG. 2 shows an example of a network architecture 200 (e.g., a disaggregated base station architecture, a disaggregated RAN architecture) that supports PC parameter configuration for full duplex symbols in a unified TCI framework in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an 02 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an AI interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-cNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., AI policies).

In some examples of network architecture 200, a UE 115-a may increase signal quality for uplink transmissions during non-SBFD symbols and SBFD symbols by operating in accordance with multiple set of PC parameters for a given TCI state. For example, a network entity 105 may transmit to the UE 115-a control information that configures the UE 115-a with a set of TCI states, where each TCI state may be configured with up to two sets of PC parameters. For instance, a first TCI state may be configured with a first set of PC parameters for non-SBFD communications and a second set of PC parameters for SBFD communications. In some examples, the first set of PC parameters include respective PC parameters (e.g., closed-loop power state index, open-loop parameters) for each of a set of types of uplink signals (e.g., separate closed-loop or open-loop parameters for SRS, PUCCH, and PUSCH).

Additionally, or alternatively the UE 115-a may determine which TCI state and which PC parameters of the TCI state to use for a given uplink transmission. In a first example, the network entity 105 may transmit an explicit indication that indicates to use a first TCI state during non-SBFD symbols and a second TCI state during SBFD symbols. For example, if both the first TCI state and the second TCI state are configured with two sets of PC parameters, the UE 115-a may use the first TCI state and the associated non-SBFD PC parameters during non-SBFD symbols and use the second TCI state and the associated SBFD PC parameters during SBFD symbols. In a second example, the UE 115-a may determine to use a single TCI state for both SBFD and non-SBFD symbols, where the UE 115-a may use the first set of PC parameters of the single TCI state for non-SBFD symbols and a second set of PC parameters of the single TCI state for SBFD symbols. In some examples, the network entity 105 may configure one or more default PC parameters at the UE 115-a to use for non-SBFD symbols, SBFD symbols, or both. For example, if a TCI state activated at the UE 115-a is not configured with PC parameters, the UE 115-a may use the default PC parameters for transmission of an uplink message during non-SBFD symbols, during SBFD symbols, or both.

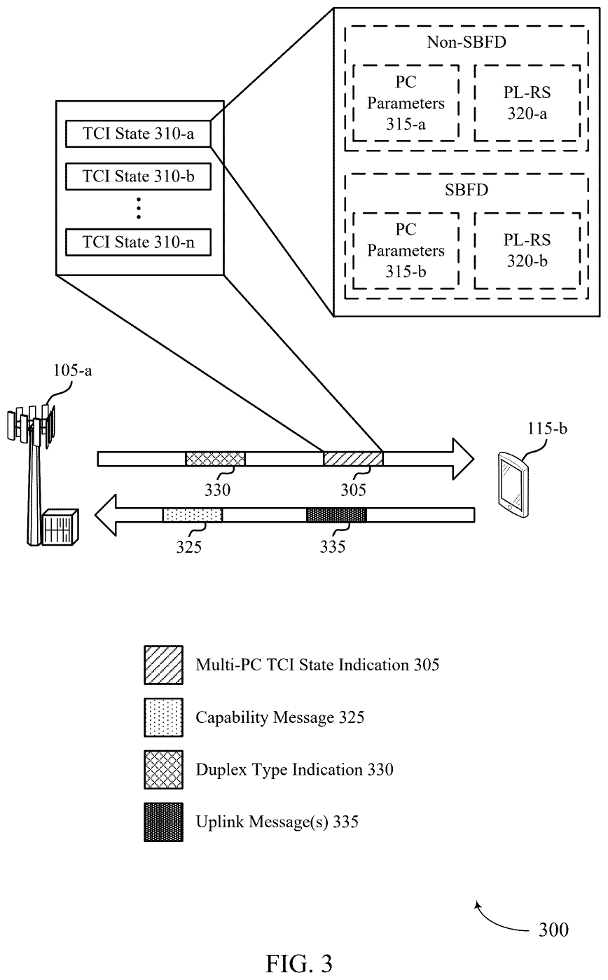

FIG. 3 shows an example of a wireless communications system 300 that supports PC parameter configuration for full duplex symbols in a unified TCI framework in accordance with one or more aspects of the present disclosure. The wireless communications system 300 may implement or may be implemented by aspects of the wireless communications system 100 and network architecture 200. For example, the wireless communications system 300 may include a network entity 105 a and a UE 115 b and, which may be respective examples of a network entity 105 and a UE 115 as described with reference to FIGS. 1 and 2.

In some examples of wireless communications system 300, the UE 115-b may transmit to the network entity 105-a one or more uplink messages 335. For example, the one or more uplink messages 335 may be one or more of PUSCH transmissions, PUCCH transmissions, SRS transmissions, among other examples of uplink transmission types. Additionally, the UE 115-b may transmit a given uplink message 335 in accordance with a set of PC parameters 315. For example, PC in wireless communication systems, (e.g., particularly in 5G networks) may involve several parameters to increase efficient and reliable uplink transmission from the UE 115-b to the network entity 105-a. These parameters may manage the uplink transmission power to maintain signal quality and reduce interference.

In some examples, a set of PC parameters 315 may include one or more open-loop PC parameters for each type of uplink message (e.g. SRS, PUCCH and PUSCH). Open-loop PC parameters may include parameters that are independent of feedback from network entity 105-a. For instance, open-loop PC parameters may include predefined parameters and estimations to set the transmission power at the UE 115-b for uplink. For instance, the open-loop PC parameters may include one or more of a PO value (e.g., a predefined initial transmit power level set for the UE 115-b that provides a starting point for uplink transmission power before any adjustments), an alpha value (e.g., a pathloss compensation factor applied to adjust the transmit power based on a path loss estimation), a path loss value (e.g., an estimated path loss used to determine the initial power level), and frequency and environmental factors (e.g., adjustments based on predefined conditions).

Additionally, or alternatively, the set of PC parameters 315 may include one or more closed-loop PC parameters (e.g., a power state). For example, closed-loop PC parameters may use feedback from the network entity 105-a to adjust the transmission power dynamically. The feedback typically includes measurements such as signal-to-noise ratio (SNR), received signal strength indicator (RSSI), or error rates. For instance, the closed-loop PC parameters may include one or more of transmit power control (TPC) commands (e.g., real-time feedback used to adjust power levels), a feedback interval (e.g., a frequency at which feedback is provided), an adjustment step size (e.g., an incremental change in power level based on feedback), target quality metrics (e.g., threshold levels of SINR, SNR, or other metrics that the network entity 105-a aims to maintain), and feedback latency (e.g., a time delay between the transmission and receipt of feedback). In some examples, the closed-loop PC parameters may be associated with or included in a closed-loop power state index.

In some cases, the UE 115-b may determine the PC parameters 315 for a given transmission in accordance with an activated TCI state 310 at the UE 115-b. For example, the network entity 105-a may configure the UE 115-b (e.g., via RRC signaling) with a set of TCI states 310, where each TCI state 310 of the set of TCI states 310 is associated with a respective set of PC parameters 315. In some examples, the configuration may indicate whether the TCI states 310 are joint TCI states 310 (e.g., each TCI state 310 may be used for both uplink and downlink communications) or separate TCI states 310 (e.g., a first subset of TCI states 310 used for uplink transmissions and a second subset of TCI states 310 used for downlink reception). Additionally, or alternatively, the network entity 105-a may further transmit a control element (e.g., a medium access control-control element (MAC-CE)) that indicates one or more TCI codepoints, where the TCI codepoints activate one or more of the configured set of TCI states 310 for use at the UE 115-b. In examples of separate TCI states 310, each TCI codepoint may indicate a pair TCI states 310 (e.g., a first TCI state 310 for uplink and a second TCI state 310 for downlink). In examples of joint TCI states 310, each TCI codepoint may indicate one TCI state 310 (e.g., a TCI state 310 for both uplink and downlink). Additionally, or alternatively, if the network entity 105-a activates multiple TCI states 310 via multiple TCI codepoints, the network entity 105-a may transmit downlink control information (DCI) that indicates a single joint TCI state 310 (e.g., or a single pair of TCI states 310) that the UE 115-b may use for communications. For instance, the DCI may be of downlink format 1_1 or 1_2 and may indicate a sticky TCI codepoint associated with one TCI codepoint of the set of activated TCI codepoints at the UE 115-b. As such, the UE 115-b may use the PC parameters 315 associated with sticky TCI codepoint for the transmission of uplink messages 335.

In some cases of wireless communications system 300, the UE 115-b may support communications in accordance with a full duplex mode (e.g., SBFD). For example, SBFD is a technique in wireless communications that allows for concurrent transmission and reception of signals within the same frequency band but on different subbands. This method may improve spectral efficiency, uplink coverage, and throughput by enabling full duplex operation while managing interference between the transmitted and received signals. In some cases, however, SBFD may be associated with increased levels of interference compared to non-SBFD (e.g., a half-duplex mode, where transmission and reception occur in different time resources or in different frequency bands). For example, SBFD communications may be associated with two primary types of interference. For instance, a first type of interference may include a static or predicted component due to self-interference at the network entity 105-a (e.g., caused by concurrent transmission and reception). Additionally, or alternatively, a second type of interference may include a random variable component due to inter-network entity CLI (e.g., signals from a first network entity 105 interfere with signals from a second network entity 105). As such, it may be advantageous for the UE 115-b to be associated with respective PC parameters 315 for transmission during non-SBFD symbols and SBFD symbols.

In accordance with the techniques described herein, the UE 115-b may be associated with TCI states 310 that correspond to multiple sets of PC parameters 315 for uplink transmission during SBFD and non-SBFD symbols. For example, as illustrated in FIG. 3, the network entity 105-a may transmit to the UE 115-b a multi-PC TCI state indication 305. In some examples, the multi-PC TCI state indication 305 may be an example of RRC signaling that configures the UE 115-b with a set of TCI states 310, where each TCI state 310 is configured with up to two sets of PC parameters 315, where each set of PC parameters 315 is associated with a specific duplex type (e.g., non-SBFD or SBFD). For instance, in the example of FIG. 3, the multi-PC TCI state indication 305 configures the UE 115-b with a set of TCI states 310 (e.g., TCI state 310-a, 310-b, and 310-n). As described herein, each of the set of TCI states 310 is either a set of joint TCI states 310 or a set of uplink-only TCI states 310. Additionally, while FIG. 3 illustrates a set of three TCI states 310, it is understood that the multi-PC TCI state indication 305 may configure the UE 115-b with any quantity of TCI states 310, where each of the TCI states 310 is configured with up to two sets of respective PC parameters 315 for non-SBFD, for SBFD symbols, or both.

As illustrated in FIG. 3, the TCI state 310-a may include two sets of PC parameters 315. For instance, PC parameters 315-a may be associated with uplink transmission during non-SBFD symbols and PC parameters 315-b may be associated with uplink transmission during SBFD symbols. In some examples, the PC parameters 315-a and 315-b may each include one or more of a respective PO value, a respective alpha value, and a respective closed-loop power state index. Additionally, or alternatively, each TCI state 310 of the set of TCI states 310 may include different path loss reference signals (PL-RSs) for SBFD and non-SBFD communications. For example, the TCI state 310-a may further include a PL-RS 320-a associated with measuring path loss during non-SBFD symbols and a PL-RS 320-b associated with measuring path loss during SBFD symbols. In some examples, a given TCI state 310 may be associated with a single set of PC parameters 315. In such examples, if the UE 115-b is operating in accordance with the given TCI state, the UE 115-b may use the single set of PC parameters 315 for uplink transmission in both non-SBFD symbols and SBFD symbols.

In some cases, the UE 115-b may transmit to the network entity 105-a a capability message 325. For example, if the UE 115-b is an SBFD-aware UE 115-b (e.g., capable of operating in an SBFD mode), the UE 115-b may transmit the capability message 325 which reports (e.g., indicates) a UE capability to support different PC parameters 315 in SBFD and non-SBFD based on a unified TCI framework configuration. Additionally, or alternatively, the capability message 325 may include an indication of additional PC parameters 315 for uplink transmission in SBFD symbols. In some examples, the UE 115-b may receive the multi-PC TCI state indication 305 in response to transmitting the capability message 325.

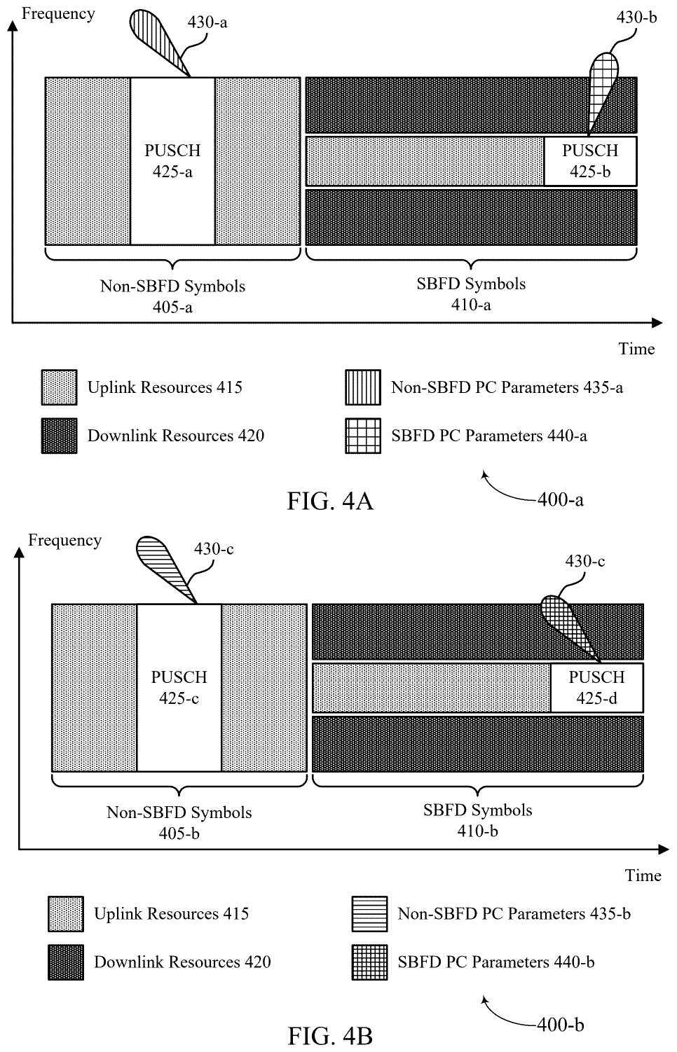

In some cases, the network entity 105-a may transmit to the UE 115-b a duplex type indication 330. In a first example, the duplex type indication 330 may be a control message (e.g., MAC-CE or DCI) that indicates that a TCI state 310 is associated with a duplex specific mode (e.g., non-SBFD only or SBFD only). Further discussion of the duplex type indication 330 operating in accordance with the first example are described herein, including with reference to FIG. 4A. In a second example, the duplex type indication 330 may indicate the type duplex state associated with a scheduled uplink message 335 (e.g., the uplink message 335 is scheduled for non-SBFD symbols or scheduled for SBFD symbols). In such a second example, if the UE 115-b is operating in accordance with TCI state 310-a, the UE 115-b may determine to use the PC parameters 315-a for uplink transmissions during non-SBFD symbols and determine to use the PC parameters 315-b for uplink transmissions during SBFD symbols. Further discussion of the duplex type indication 330 operating in accordance with the second example are described herein, including with reference to FIG. 4B.

As described herein, SBFD symbols may be associated with static interference (e.g., based on UE self-interference), random variable interference (e.g., based on inter-network entity CLI), or both. In some examples, fixed PC parameters 315 included in open-loop PC parameters may be used reduce static or fixed interference. For instance, the UE 115-b may use an increased PO value, an increased alpha value, or both to reduce the static interference. Additionally, or alternatively, closed-loop PC parameters may be used to reduce dynamic interference. For instance, the network entity 105-a and UE 115-b may use separate closed-loop power state and dynamic TPC commands or other closed-loop parameters to reduce dynamic interference at the UE 115-b.

In some cases, the PC parameters 315-a associated with non-SBFD may include a first set of open-loop PC parameters and a first closed-loop PC index and the PC parameters 315-b associated with SBFD may include a second set of open-loop PC parameters and a second closed-loop PC index. In a first implementation, the first set of open-loop PC parameters may be different than the second set of open-loop PC parameters (e.g., different PO value and different alpha value for SBFD and non-SBFD), and the first closed-loop PC index and the second closed-loop PC index may be the same. In a first example of the first implementation, the second set of open-loop PC parameters may include power offsets relative to the first set of open-loop PC parameters (e.g., a PO offset value relative to the PO value used for non-SBFD and an alpha offset value relative to the alpha value used for non-SBFD). In a second example of the first implementation, the first set of open-loop PC parameters may include power offsets relative to the second set of open-loop PC parameters (e.g., a PO offset value relative to the PO value used for SBFD and an alpha offset value relative to the alpha value used for SBFD). In some examples, the network entity 105-a may configure the UE 115-b with PC parameters 315-a and 315-b according to the first implementation if static interference is above a first threshold, if dynamic interference is below a second threshold, or both (e.g., cases where static interference is the dominant type of interference).

In a second implementation, the first closed-loop power state index may be different from the second closed-loop power state index (e.g., different closed-loop PC parameters for SBFD and non-SBFD and different TPC commands for SBFD and non-SBFD symbols) and the first set of open-loop PC parameters and the second set of open-loop PC parameters may be the same. For example, when the open-loop PC parameters are absent (e.g., not configured) for the SBFD PC parameters, the UE 115-b may assume the same configured PC parameters for non-SBFD symbols. As such, the different closed-loop indexes may enable the network entity 105-a and UE 115-b to communicate different TPC commands for uplink transmissions between SBFD and non-SBFD. In some examples, the network entity 105-a may configure the UE 115-b with PC parameters 315-a and 315-b according to the second implementation if static interference is below a first threshold, if dynamic interference is above a second threshold, or both (e.g., cases where dynamic interference is the dominant type of interference).

In a third implementation, the first set of open-loop PC parameters and the second set of open-loop PC parameters may be different, and the first closed-loop PC index and the second closed-loop PC index may be different (e.g., different PO value, different alpha value, and different closed-loop power state index used for SBFD and non-SBFD).

In some cases, a default uplink PC parameter setting (e.g., for PUSCH, PUCCH, and SRS) may be configured for non-SBFD symbols, for SBFD symbols, or both. For example, the multi-PC TCI state indication 305 may indicate (e.g., in BWP-UplinkDedicated) a first set of default PC parameters 315 for use in non-SBFD symbols, a second set of default PC parameters 315 for use in SBFD symbols, or both. As such, if the indicated TCI state 310 applied to an uplink message 335 does not include an uplink PC parameter setting for uplink transmissions, the UE 115-b shall apply the first set of default PC parameters 315 for an uplink transmission during non-SBFD symbols and may apply the second set of default PC parameters 315 for an uplink transmission during SBFD symbols (e.g., configured in BWP-UplinkDedicated).

As described herein, the UE may be provided by the network entity with a set of TCI states 310 (e.g., via TCIState in dl-OrJoint-TCIStateList or via UL-TCIstate). Additionally, or alternatively, the indicated TCIState or UL-TCIstate may be provided with two sets of PC parameters 315 (e.g., Uplink-powerControlld-r17 and ul-powerControl-r19) and two sets PL-RSs 320 (e.g., pathlossReferenceRS-Id-r17 and pathlossReferenceRS-Id-r19) for uplink transmission in SBFD and non SBFD symbols respectively. In some examples, a reference signal index (e.g., q_{d}) for obtaining the downlink pathloss estimate for PUSCH and PUCCH transmissions may be provided by the respective PL-RS 320 associated with or included in the indicated TCIState or UL-TCIstate. Additionally or alternatively, downlink pathloss estimate for SRS transmissions may be provided in follow UnifiedTCIstateSRS separately for SBFD and non-SBFD symbols based on the provided PL-RS resources respectively.

In examples of PUSCH transmissions, if two p0AlphaSetforPUSCH values are provided, the values of PO UE PUSCH.I.J.B. C.J.B, and the PUSCH PC adjustment state I may be provided by the p0AlphaSetforPUSCH associated with the indicated TCIState or UL-TCIstate based on the symbol type of the PUSCH (e.g., non-SBFD or SBFD).

In examples of PUCCH, if two p0AlphaSetforPUCCH are provided, the values of PO PUCCH.I.J.BG and the PUCCH PC adjustment state may be provided by the p0AlphaSetforPUCCH associated with the indicated TCIState or UL-TCIstate based on the symbol type of the PUCCH (e.g., non-SBFD or SBFD).

In examples of SRS, if two p0AlphaSetforSRS are provided, and the follow UnifiedTO Istate SRS is provided for a SRS resource set, the values of Po SRS.L.J.BK, Q SRS.I.J.BK, and SRS PC adjustment state may be provided by the p0AlphaSetforSRS associated with the indicated TOIState or UL-TCIState based on the symbol type of SRS (e.g., non-SBFD or SBFD).

FIGS. 4A and 4B each show an example of a multi-PC transmission timeline 400-a and 400-b that supports PC parameter configuration for full duplex symbols in a unified TCI framework in accordance with one or more aspects of the present disclosure. The multi-PC transmission timeline 400-a and 400-b may implement or may be implemented by aspects of the wireless communications system 100, network architecture 200, and wireless communications system 300. For example, the multi-PC transmission timeline 400-a and 400-b may illustrate respective transmission timelines indicating transmission of multiple PUSCH transmissions 425 using respective sets of PC parameters during non-SBFD symbols 405 and SBFD symbols 410. Additionally, while FIGS. 4A and 4B are illustrated as independent examples, it is understood that a UE 115 and a network entity 105 may apply the techniques of multi-PC transmission timeline 400-a and 400-b independently or in combination.

As illustrated in FIG. 4A, the multi-PC transmission timeline 400-a may span a set of non-SBFD symbols 405-a and a set of SBFD symbols 410-a. For example, the set of non-SBFD symbols 405-a may span a set of uplink resources 415 that includes a set of frequency resources (e.g., frequency band, carrier, bandwidth part) and a set of time resources (e.g., frames, subframes, slots, subslots, or symbols). Additionally, the set of SBFD symbols 410-a may span a set of uplink resources 415 and a set of downlink resources 420. For instance, the downlink resources 415 may span a first and second subband of the frequency band and the uplink resources 415 may span a third subband that is in between the first and second subband. Additionally, the SBFD symbols 410-a illustrate a single configuration of uplink resources 415 and downlink resources 420, however it is understood that the SBFD symbols 410-a may be configured into any quantity of uplink subbands and downlink subbands in any pattern or orientation.

In the example of FIG. 4A, the network entity 105 may schedule the UE 115 for a PUSCH transmission 425-a during the uplink resources 415 of the non-SBFD symbols 405-a and may schedule the UE 115 for a PUSCH transmission 425-b during the uplink resources 415 of the SBFD symbols 410-a. In some examples, the PUSCH transmissions 425 may be respective examples of uplink messages 335, as described with reference to FIG. 3. For example, while examples are described with reference to PUSCH transmission 425, it is understood that such techniques may be applied to PUCCH transmissions, SRS transmissions, or any other type of uplink transmission type.

The techniques of multi-PC transmission timeline 400-a may operate in accordance with the multi-PC TCI state indication 305 and the duplex type indication 330, as described with reference to FIG. 3. For example, the network entity 105 may transmit multi-PC TCI state indication 305 configuring the UE 115 with at least a first TCI sate and a second TCI state, each associated with up to two sets of PC parameters. In the example of FIG. 4A, it is assumed that the first TCI state is associated with a first set of non-SBFD PC parameters associated with a first index ID (e.g., ul-powerControl-r17; ID ‘n’) and a first set of SBFD PC parameters 440-a associated with a first index ID (e.g., ul-powerControl-r19; ID ‘x’), and that the second TCI state is associated with a second set of non-SBFD PC parameters 440-a associated with a second index ID (e.g., ul-powerControl-r17; ID ‘m’) and a second set of SBFD PC parameters associated with a second index ID (e.g., ul-powerControl-r19; ID ‘y’). In some examples, the multi-PC TCI state indication 305 may additionally indicate a respective beam 430 that the first TCI state and second TCI state are associated with. For example, the multi-PC TCI state indication 305 may indicate that first TCI state is associated with beam 430-a (e.g., a first synchronization signal block (SSB)) and that the second TCI state is associated with beam 430-b (e.g., a second SSB).

In accordance with multi-PC transmission timeline 400-a, if a given TCI state is configured with two sets of PC parameters and is activated for duplex-specific symbols, the UE 115 may utilize the set of PC parameters (e.g., and the PL-RS associated) for uplink transmission based on duplex type. For example, the UE 115 may receive the duplex type indication 330 which indicates whether a given TCI state is associated with SBFD communications or non-SBFD communications. For instance, in the example of FIG. 4A, the duplex type indication 330 may indicate that the first TCI state is associated with non-SBFD communications and that the second TCI state is associated with SBFD communications. In this example, the UE 115 may utilize different beams for uplink transmission in SBFD and non-SBFD.

In some cases of multi-PC transmission timeline 400-a, the duplex type indication 330 may be a control signal (e.g., a MAC-CE or a DCI). In a first example, the duplex type indication 330 may be an activating MAC-CE command that includes an explicit bitfield to indicate the duplex type of each activated TCI codepoint or TCI state. In the example of FIG. 4A, the explicit bitfield may indicate that the UE 115 is to use the first TCI state for non-SBFD communications and indicate that the UE 115 is to use the second TCI state for SBFD communications. In a second example, the duplex type indication 330 may be a DCI message (e.g., of format 1_1 or 1_2) that includes an explicit duplex field indicator for the indicated TCI codepoints or TCI states in the DCI message. In the example of FIG. 4A, the explicit duplex field indicator may indicate that the UE 115 is to use the first TCI state for non-SBFD communications and indicate that the UE 115 is to use the second TCI state for SBFD communications.

In accordance with receiving the duplex type indication 330, the UE 115 may determine to use non-SBFD PC parameters 435-a of the first TCI state (e.g., ul-powerControl-r17; ID ‘m’) during the non-SBFD symbols 405-a and use the SBFD PC parameters 440-a of the second TCI state (e.g., ul-powerControl-r19; ID ‘x’). For example, as illustrated in FIG. 4A, the UE 115 may transmit PUSCH transmission 425-a using beam 430-a in accordance with the non-SBFD PC parameters 435-a of the first TCI state and then transmit PUSCH transmission 425-b using beam 430-b in accordance with the SBFD PC parameters 440-a of the second TCI state.

As illustrated in FIG. 4B, the multi-PC transmission timeline 400-b may span a set of non-SBFD symbols 405-b and a set of SBFD symbols 410-b. For example, the set of non-SBFD symbols 405-b may span a set of uplink resources 415 that includes a set of frequency resources (e.g., frequency band, carrier, bandwidth part) and a set of time resources (e.g., frames, subframes, slots, subslots, or symbols). Additionally, the set of SBFD symbols 410-b may span a set of uplink resources 415 and a set of downlink resources 420. For instance, the downlink resources 415 may span a first and second subband of the frequency band and the uplink resources 415 may span a third subband that is in between the first and second subband. Additionally, the SBFD symbols 410-b illustrate a single configuration of uplink resources 415 and downlink resources 420, however it is understood that the SBFD symbols 410-b may be configured into any quantity of uplink subbands and downlink subbands in any pattern or orientation.

In the example of FIG. 4B, the network entity 105 may schedule the UE 115 for a PUSCH transmission 425-c during the uplink resources 415 of the non-SBFD symbols 405-b and may schedule the UE 115 for a PUSCH transmission 425-d during the uplink resources 415 of the SBFD symbols 410-b.

The techniques of multi-PC transmission timeline 400-a may operate in accordance with the multi-PC TCI state indication 305 and the duplex type indication 330, as described with reference to FIG. 3. For example, the network entity 105 may transmit multi-PC TCI state indication 305 configuring the UE 115 with at least a first TCI sate associated with two sets of PC parameters. In the example of FIG. 4B, it is assumed that the first TCI state is associated with a set of non-SBFD PC parameters 435-b associated with a first index ID (e.g., ul-powerControl-r17; ID ‘a’) and a set of SBFD PC parameters 440-b associated with a first index ID (e.g., ul-powerControl-r19; ID ‘b’). The set of non-SBFD PC parameters 435-b and the set of SBFD PC parameters 440-b may be the same or different than the set of non-SBFD PC parameters 435-a and the set of SBFD PC parameters 440-a as described with reference to FIG. 4A. In some examples, the multi-PC TCI state indication 305 may additionally indicate a respective beam 430 that the first TCI state. For example, the multi-PC TCI state indication 305 may indicate that first TCI state is associated with beam 430-c (e.g., a third SSB).

In accordance with multi-PC transmission timeline 400-b, if a TCI state is configured with two sets of PC parameters and is not associated with specific duplex type (e.g., may be used for both SBFD and non-SBFD), the UE 115 may utilize each set of PC parameters (e.g., and the PL-RS associated with each set of PC parameters) for uplink transmission based on duplex type. In this example, the UE 115 may utilize the same beam 430-c for uplink transmission in SBFD and non-SBFD symbols, in accordance with two different PC parameters. For example, the UE 115 may receive the duplex type indication 330 which indicates that the PUSCH transmission 425-c is scheduled during the non-SBFD symbols 405-a and indicates that the PUSCH transmission 425-d is scheduled during the SBFD symbols 410-a. Duplex type indication 330 may be one or more control messages (e.g., RRC, MAC-CE, or DCI) that schedule the UE 115 for one or more uplink transmissions during non-SBFD symbols 405-b, during SBFD symbols 410-b, or both.

In accordance with multi-PC transmission timeline 400-b, the UE 115 may semi-statically switch the PC parameters for uplink transmission in accordance with the symbol type. For example, in response to receiving the duplex type indication 330, the UE 115 may determine to use non-SBFD PC parameters 435-b of the first TCI state (e.g., ul-powerControl-r17; ID ‘a’) during the non-SBFD symbols 405-b and use the SBFD PC parameters 440-b of the first TCI state (e.g., ul-powerControl-rl; ID ‘b’). For example, as illustrated in FIG. 4B, the UE 115 may transmit PUSCH transmission 425-c using beam 430-c in accordance with the non-SBFD PC parameters 435-b of the first TCI state and then transmit PUSCH transmission 425-d using beam 430-c in accordance with the SBFD PC parameters 440-b of the first TCI state.

In some examples, the UE 115 may be configured with a single set of PC parameters. In such examples, the UE 115 may transmit the same PC parameters for both non-SBFD communications and SBFD communications. For example, if the first TCI state configured at the UE 115 is associated with a single set of PC parameters associated with beam 430-c, the UE 115 may transmit the PUSCH transmission 425-c using beam 430-c in accordance with the single set of PC parameters and transmit PUSCH transmission 425-d using beam 430-c in accordance with the single set of PC parameters.

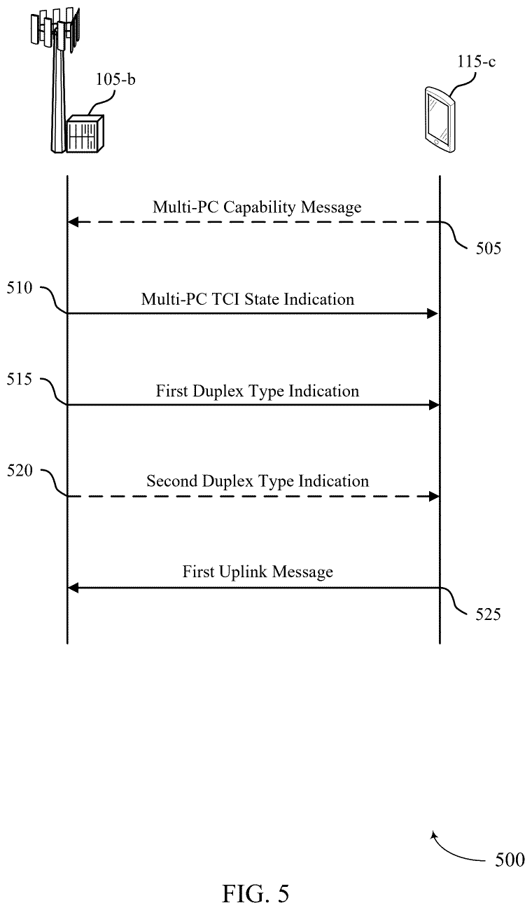

FIG. 5 shows an example of a process flow 500 that supports PC parameter configuration for full duplex symbols in a unified TCI framework in accordance with one or more aspects of the present disclosure. In some examples, process flow 500 may implement aspects of wireless communications system 100, network architecture 200, wireless communications system 300, multi-PC transmission timeline 400 a, and multi-PC transmission timeline 400 b. Process flow 500 may include a UE 115 c which may be an example of a UE 115, as described with reference to FIGS. 1 through 4. Additionally, process flow 500 may include a network entity 105 b which may be an example of a network entity 105, as described with reference to FIGS. 1 through 4. Alternative examples of the following may be implemented, where some steps are performed in a different order than described or are not performed at all. In some cases, steps may include additional features not mentioned below, or further steps may be added. In addition, it is understood that these processes may occur between any quantity of network devices and network device types.

At 505, the UE 115-c may optionally transmit to the network entity 105-b a capability message that indicates that the UE 115-c supports multiple PC parameter sets associated with different symbol duplex types for a single TCI state. In some cases, the capability message may be an example of capability message 325, as described with reference to FIG. 3.

At 510, the UE 115-c may receive from the network entity 105-b a multi-PC TCI state indication. For example, the UE 115-c may receive control information (e.g., RRC signaling) that indicates a set of TCI states. For instance, a first TCI state of the set of TCI states may be associated with a first set of PC parameters (e.g., for non-SBFD symbols) and a second set of PC parameters (e.g., for SBFD symbols). In some cases, the multi-PC TCI state indication may be an example of multi-PC TCI state indication 305 as described with reference to FIG. 3. In some examples, the set of TCI states may include a set of joint uplink and downlink TCI states or a set of uplink-only TCI states. In some examples, a second TCI state of the set of TCI states may be associated with a single set of PC parameters for uplink transmissions by the UE 115-c during non-SBFD symbols and during SBFD symbols. Additionally, or alternatively, the UE 115-c may receive the control information based on transmitting the capability message.

Additionally, or alternatively, the UE 115-c may receive as part of the control information, an indication that the first TCI state is further associated with a first PL-RS for pathloss measurements during non-SBFD symbols and a second PL-RS for pathloss measurements during SBFD symbols.

In some examples, the first set of PC parameters may include a first closed-loop power state index and a first set of open-loop parameters, and the second set of PC parameters may include the first closed-loop power state index and a second set of open-loop parameters that are different than the first set of open-loop parameters. In such examples, the second set of open-loop parameters may be a set of power offset values relative to the first set of open-loop parameters.

In some examples, the first set of PC parameters may include a first set of open-loop parameters and a first closed-loop power state index, and the second set of PC parameters may include the first set of open-loop parameters and a second closed-loop power state index that is different than the first closed-loop power state index.

At 515, the UE 115-c may receive from the network entity 105-b a first duplex type indication. For example, the UE 115-c may receive an indication of a duplex type for one or more symbols including uplink resources, where the one or more symbols are associated with the first TCI state. In some cases, the first duplex type indication may be an example of the duplex type indication 330, as described with reference to FIG. 3.

In a first example of the first duplex type indication, the UE 115-c may receive, as part of a control message, a first indication for the UE 115-c to use the first TCI state for uplink messages scheduled during SBFD symbols. In such a first example, the UE 115-c may transmit a first uplink message during one or more symbols according to the second set of PC parameters of the first TCI state based on the duplex type of the one or more symbols being SBFD. Additionally, or alternatively, the set of TCI states may include a second TCI state associated with at least a third set of PC parameters for uplink transmissions by the UE 115-c during non-SBFD symbols and the UE 115-c may receive, as part of the control message, a second indication for the UE 115-c to use the second TCI state for uplink messages scheduled during non-SBFD symbols. As such, the UE 115-c may transmit a second uplink message during one or more second symbols according to the second TCI state, where the second uplink message is transmitted according to the third set of PC parameters based on the one or more second symbols being non-SBFD and the second TCI state being associated with the third set of PC parameters. In some cases, the control message is a MAC-CE command that includes a bitfield that indicates that the first TCI state is associated with SBFD symbols. In some cases, the control message may be a DCI message that includes a duplex field indicator that indicates that the first TCI state is associated with SBFD symbols.

In a second example of the first duplex indication, the first duplex indication may indicate for the UE 115-c to transmit a first uplink message during one or more SBFD symbols in accordance with the first TCI state. As such, the UE 115-c may transmit the first uplink message during the one or more SBFD symbols according to the first TCI state, where the first uplink message is transmitted according to the second set of PC parameters based on the duplex type being SBFD and the first TCI state being associated with the second set of PC parameters. Additionally, or alternatively, the UE 115-c may optionally receive a second indication for one or more second symbols including second uplink resources of a second duplex type, where the one or more second symbols are associated with the first TCI state. The UE 115-c may transmit a second uplink message during the one or more second symbols according to the first TCI state, where the second uplink message is transmitted according to the first set of PC parameters based on the second duplex type being non-SBFD and the first TCI state being associated with the first set of PC parameters.

At 520, the UE 115-c may optionally receive a second duplex type indication for one or more second symbols including uplink resources, where the one or more second symbols are associated with a second TCI state that is not configured with a set of PC parameters. The UE 115-c may transmit a second uplink message during the one or more second symbols according to the second TCI state, where the second uplink message is transmitted according to a third set of PC parameters based on the second duplex type and the second TCI state not being associated with a set of PC parameters. In some examples, the third set of PC parameters may be configured in BWP-UplinkDedicated for SBFD symbols, for non-SBFD symbols, or both.

At 525, the UE 115-c may transmit one or more uplink messages to the network entity 105-b in accordance with one or more TCI states and the one or more PC parameters configured for each of the one or more TCI states. For example, the UE 115-c may transmit the one or more uplink messages in accordance with the first duplex type indication, the second duplex type indication, or both.

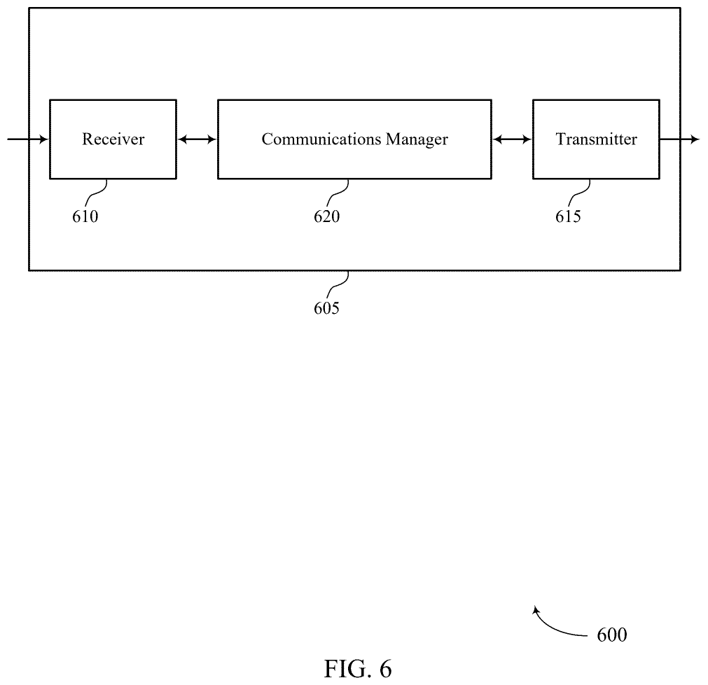

FIG. 6 shows a block diagram 600 of a device 605 that supports PC parameter configuration for full duplex symbols in a unified TCI framework in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to PC parameter configuration for full duplex symbols in a unified TCI framework). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to PC parameter configuration for full duplex symbols in a unified TCI framework). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of PC parameter configuration for full duplex symbols in a unified TCI framework as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving control information that indicates a set of TCI states, where a first TCI state of the set of TCI states is configured with a first set of PC parameters associated with uplink transmission in non-full duplex symbols and a second set of PC parameters associated with uplink transmission in full duplex symbols. The communications manager 620 is capable of, configured to, or operable to support a means for receiving an indication of a duplex type for one or more TCI states of the set of TCI states; and. The communications manager 620 is capable of, configured to, or operable to support a means for transmitting an uplink message according to the first TCI state, where the uplink message is transmitted according to the second set of PC parameters based on the duplex type of the first TCI state being full duplex.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, and more efficient utilization of communication resources.

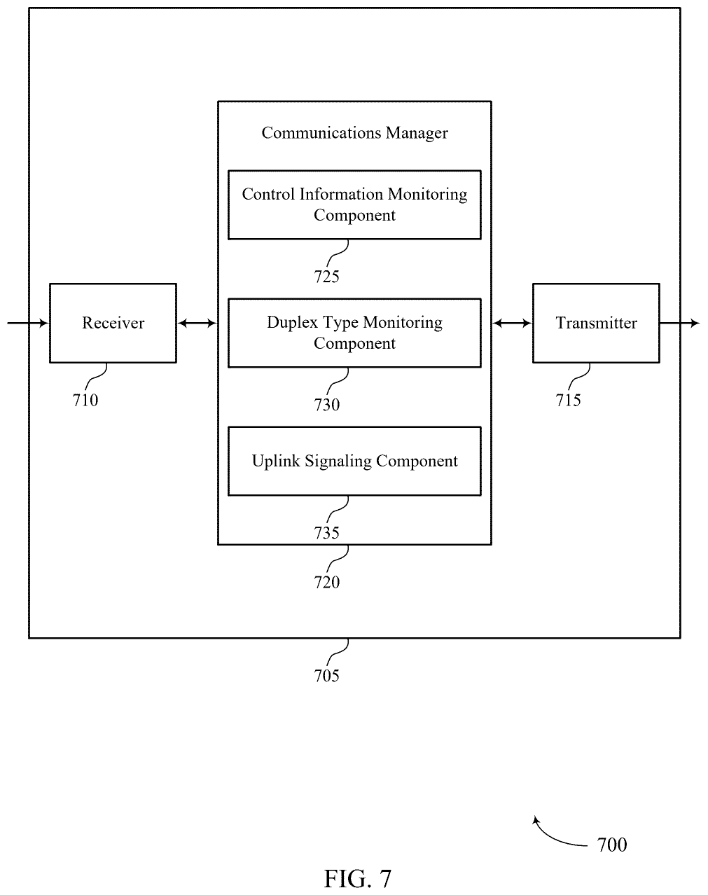

FIG. 7 shows a block diagram 700 of a device 705 that supports PC parameter configuration for full duplex symbols in a unified TCI framework in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to PC parameter configuration for full duplex symbols in a unified TCI framework). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to PC parameter configuration for full duplex symbols in a unified TCI framework). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of PC parameter configuration for full duplex symbols in a unified TCI framework as described herein. For example, the communications manager 720 may include a control information monitoring component 725, a duplex type monitoring component 730, an uplink signaling component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The control information monitoring component 725 is capable of, configured to, or operable to support a means for receiving control information that indicates a set of TCI states, where a first TCI state of the set of TCI states is configured with a first set of PC parameters associated with uplink transmission in non-full duplex symbols and a second set of PC parameters associated with uplink transmission in full duplex symbols. The duplex type monitoring component 730 is capable of, configured to, or operable to support a means for receiving an indication of a duplex type for one or more TCI states of the set of TCI states; and. The uplink signaling component 735 is capable of, configured to, or operable to support a means for transmitting an uplink message according to the first TCI state, where the uplink message is transmitted according to the second set of PC parameters based on the duplex type of the first TCI state being full duplex.

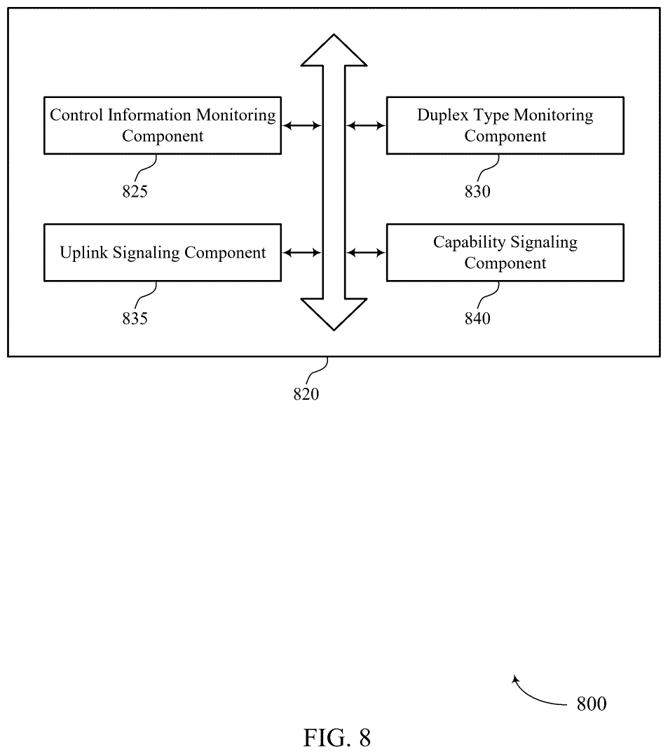

FIG. 8 shows a block diagram 800 of a communications manager 820 that supports PC parameter configuration for full duplex symbols in a unified TCI framework in accordance with one or more aspects of the present disclosure. The communications manager 820 may be an example of aspects of a communications manager 620, a communications manager 720, or both, as described herein. The communications manager 820, or various components thereof, may be an example of means for performing various aspects of PC parameter configuration for full duplex symbols in a unified TCI framework as described herein. For example, the communications manager 820 may include a control information monitoring component 825, a duplex type monitoring component 830, an uplink signaling component 835, a capability signaling component 840, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The control information monitoring component 825 is capable of, configured to, or operable to support a means for receiving control information that indicates a set of TCI states, where a first TCI state of the set of TCI states is configured with a first set of PC parameters associated with uplink transmission in non-full duplex symbols and a second set of PC parameters associated with uplink transmission in full duplex symbols. The duplex type monitoring component 830 is capable of, configured to, or operable to support a means for receiving an indication of a duplex type for one or more TCI states of the set of TCI states; and. The uplink signaling component 835 is capable of, configured to, or operable to support a means for transmitting an uplink message according to the first TCI state, where the uplink message is transmitted according to the second set of PC parameters based on the duplex type of the first TCI state being full duplex.

In some examples, the control information monitoring component 825 is capable of, configured to, or operable to support a means for receiving, as part of the control information, a first indication that the first TCI state is further configured with a first pathloss reference signal for pathloss measurements associated with non-full duplex symbols and a second pathloss reference signal for pathloss measurements associated with full duplex symbols.

In some examples, to support receiving the indication of the duplex type, the control information monitoring component 825 is capable of, configured to, or operable to support a means for receiving, as part of a control message, a first indication for the UE to use the first TCI state for uplink messages scheduled during full duplex symbols, where transmitting the uplink message during one or more symbols according to the second set of PC parameters of the first TCI state is based on the duplex type of the one or more symbols being full duplex.

In some examples, the set of TCI states includes a second TCI state configured with at least a third set of PC parameters associated with uplink transmission in non-full duplex symbols, and the control information monitoring component 825 is capable of, configured to, or operable to support a means for receiving, as part of the control message, a second indication for the UE to use the second TCI state for uplink messages scheduled during non-full duplex symbols. In some examples, the set of TCI states includes a second TCI state configured with at least a third set of PC parameters associated with uplink transmission in non-full duplex symbols, and the uplink signaling component 835 is capable of, configured to, or operable to support a means for transmitting a second uplink message during one or more second symbols according to the second TCI state, where the second uplink message is transmitted according to the third set of PC parameters based on the one or more second symbols being non-full duplex.

In some examples, the control message is a MAC-CE command including a bitfield that indicates that the first TCI state is associated with full duplex symbols.

In some examples, the control message is a DCI message including a duplex field indicator that indicates that the first TCI state is associated with full duplex symbols.

In some examples, the set of TCI states includes a third TCI state configured with a fourth set of PC parameters associated with uplink transmission in non-full duplex symbols and a fifth set of PC parameters associated with uplink transmission in full duplex symbols, and the control information monitoring component 825 is capable of, configured to, or operable to support a means for receiving, as part of the indication of the duplex type for the one or more TCI states of the set of TCI states, that the third TCI state is associated with both full duplex symbols and non-full duplex symbols. In some examples, the set of TCI states includes a third TCI state configured with a fourth set of PC parameters associated with uplink transmission in non-full duplex symbols and a fifth set of PC parameters associated with uplink transmission in full duplex symbols, and the uplink signaling component 835 is capable of, configured to, or operable to support a means for transmitting a second uplink message during one or more non-full duplex symbols according to the third TCI state, where the second uplink message is transmitted according to the fourth set of PC parameters based on the second uplink message being scheduled during the one or more non-full duplex symbols. In some examples, the set of TCI states includes a third TCI state configured with a fourth set of PC parameters associated with uplink transmission in non-full duplex symbols and a fifth set of PC parameters associated with uplink transmission in full duplex symbols, and the uplink signaling component 835 is capable of, configured to, or operable to support a means for transmitting a third uplink message during one or more full duplex symbols according to the third TCI state, where the third uplink message is transmitted according to the fifth set of PC parameters based on the second uplink message being scheduled during the one or more full duplex symbols.

In some examples, the first set of PC parameters include a respective first closed-loop power state index and a respective first set of open-loop parameters for each of a set of types of uplink signals (e.g., separate closed-loop and open-loop parameters for SRS, PUCCH, and PUSCH). In some examples, the second set of PC parameters include the respective first closed-loop power state index and a respective second set of open-loop parameters that are different than the respective first set of open-loop parameters for each of the set of types of uplink signals.

In some examples, each respective second set of open-loop parameters includes a set of power offset values relative to a corresponding respective first set of open-loop parameters.

In some examples, the first set of PC parameters include a respective first set of open-loop parameters and a respective first closed-loop power state index for each of a set of types of uplink signals. In some examples, the second set of PC parameters include the respective first set of open-loop parameters and a respective second closed-loop power state index that is different than the respective first closed-loop power state index for each of the set of types of uplink signals.

In some examples, the control information monitoring component 825 is capable of, configured to, or operable to support a means for receiving a configuration of a first default set of PC parameters associated with uplink transmission in non-full duplex symbols and a second default set of PC parameters associated with uplink transmission in full duplex symbols. In some examples, the control information monitoring component 825 is capable of, configured to, or operable to support a means for receiving, as part of the indication of the duplex type for the one or more TCI states of the set of TCI states, an indication that that a fourth TCI state is associated with full duplex symbols, where the fourth TCI state is not configured with any set of PC parameters. In some examples, the uplink signaling component 835 is capable of, configured to, or operable to support a means for transmitting a second uplink message according to a fourth TCI state, where the second uplink message is transmitted according to the second default set of PC parameters based on the duplex type of the fourth TCI state being full duplex and the fourth TCI state not being configured with any set of PC parameters.

In some examples, the capability signaling component 840 is capable of, configured to, or operable to support a means for transmitting a capability message that indicates that the UE supports multiple PC parameter sets associated with different symbol duplex types for a single TCI state, where receiving the control information is based on transmitting the capability message.

In some examples, the set of TCI states includes a set of joint uplink and downlink TCI states or a set of uplink-only TCI states.

In some examples, a second TCI state of the set of TCI states is associated with a single set of PC parameters for uplink transmissions by the UE during non-duplex symbols and during full duplex symbols.

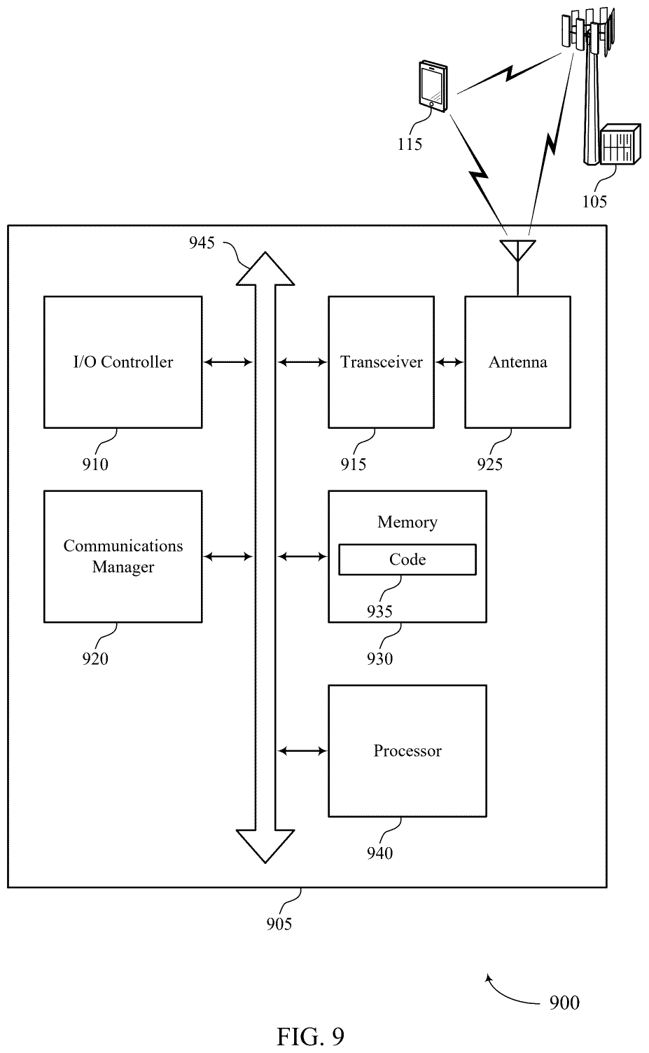

FIG. 9 shows a diagram of a system 900 including a device 905 that supports PC parameter configuration for full duplex symbols in a unified TCI framework in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting PC parameter configuration for full duplex symbols in a unified TCI framework). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving control information that indicates a set of TCI states, where a first TCI state of the set of TCI states is configured with a first set of PC parameters associated with uplink transmission in non-full duplex symbols and a second set of PC parameters associated with uplink transmission in full duplex symbols. The communications manager 920 is capable of, configured to, or operable to support a means for receiving an indication of a duplex type for one or more TCI states of the set of TCI states; and. The communications manager 920 is capable of, configured to, or operable to support a means for transmitting an uplink message according to the first TCI state, where the uplink message is transmitted according to the second set of PC parameters based on the duplex type of the first TCI state being full duplex.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of PC parameter configuration for full duplex symbols in a unified TCI framework as described herein, or the at least one processor 940 and the at least one memory 930 may be otherwise configured to, individually or collectively, perform or support such operations.

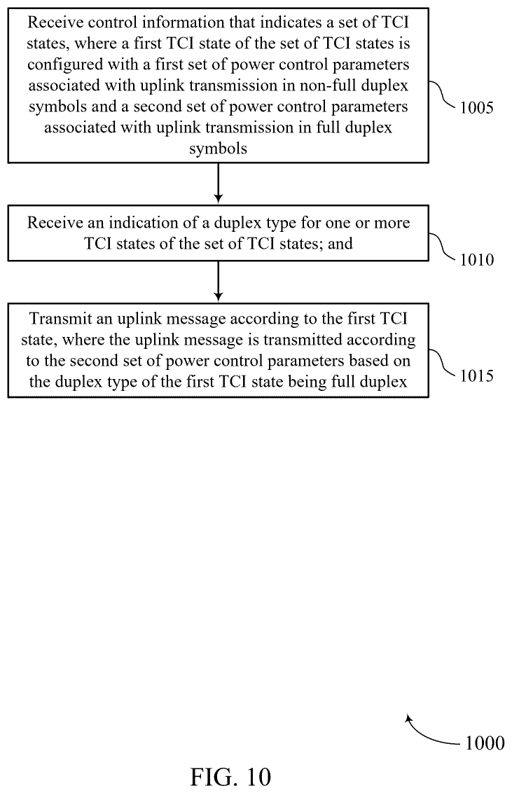

FIG. 10 shows a flowchart illustrating a method 1000 that supports PC parameter configuration for full duplex symbols in a unified TCI framework in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving control information that indicates a set of TCI states, where a first TCI state of the set of TCI states is configured with a first set of PC parameters associated with uplink transmission in non-full duplex symbols and a second set of PC parameters associated with uplink transmission in full duplex symbols. The operations of 1005 may be performed in accordance with examples as disclosed herein. In some examples, aspects of the operations of 1005 may be performed by a control information monitoring component 825 as described with reference to FIG. 8.

At 1010, the method may include receiving an indication of a duplex type for one or more TCI states of the set of TCI states; and. The operations of 1010 may be performed in accordance with examples as disclosed herein. In some examples, aspects of the operations of 1010 may be performed by a duplex type monitoring component 830 as described with reference to FIG. 8.

At 1015, the method may include transmitting an uplink message according to the first TCI state, where the uplink message is transmitted according to the second set of PC parameters based on the duplex type of the first TCI state being full duplex. The operations of 1015 may be performed in accordance with examples as disclosed herein. In some examples, aspects of the operations of 1015 may be performed by an uplink signaling component 835 as described with reference to FIG. 8.

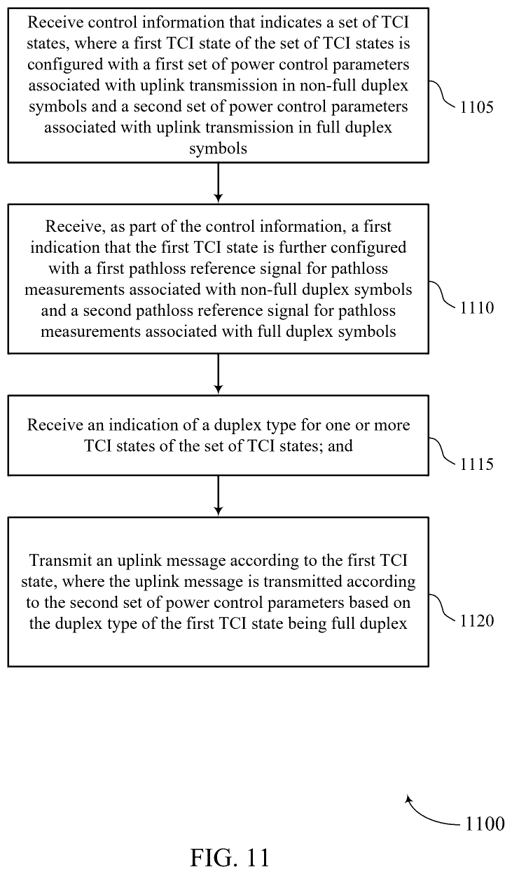

FIG. 11 shows a flowchart illustrating a method 1100 that supports PC parameter configuration for full duplex symbols in a unified TCI framework in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving control information that indicates a set of TCI states, where a first TCI state of the set of TCI states is configured with a first set of PC parameters associated with uplink transmission in non-full duplex symbols and a second set of PC parameters associated with uplink transmission in full duplex symbols. The operations of 1105 may be performed in accordance with examples as disclosed herein. In some examples, aspects of the operations of 1105 may be performed by a control information monitoring component 825 as described with reference to FIG. 8.

At 1110, the method may include receiving, as part of the control information, a first indication that the first TCI state is further configured with a first pathloss reference signal for pathloss measurements associated with non-full duplex symbols and a second pathloss reference signal for pathloss measurements associated with full duplex symbols. The operations of 1110 may be performed in accordance with examples as disclosed herein. In some examples, aspects of the operations of 1110 may be performed by a control information monitoring component 825 as described with reference to FIG. 8.

At 1115, the method may include receiving an indication of a duplex type for one or more TCI states of the set of TCI states; and. The operations of 1115 may be performed in accordance with examples as disclosed herein. In some examples, aspects of the operations of 1115 may be performed by a duplex type monitoring component 830 as described with reference to FIG. 8.

At 1120, the method may include transmitting an uplink message according to the first TCI state, where the uplink message is transmitted according to the second set of PC parameters based on the duplex type of the first TCI state being full duplex. The operations of 1120 may be performed in accordance with examples as disclosed herein. In some examples, aspects of the operations of 1120 may be performed by an uplink signaling component 835 as described with reference to FIG. 8.

The following provides an overview of aspects of the present disclosure:
Aspect 1: A method for wireless communications, at a UE, comprising: receiving control information that indicates a set of TCI states, wherein a first TCI state of the set of TCI states is configured with a first set of PC parameters associated with uplink transmission in non-full duplex symbols and a second set of PC parameters associated with uplink transmission in full duplex symbols; receiving an indication of a duplex type for one or more TCI states of the set of TCI states; and transmitting an uplink message according to the first TCI state, wherein the uplink message is transmitted according to the second set of PC parameters based at least in part on the duplex type of the first TCI state being full duplex.
Aspect 2: The method of aspect 1, further comprising: receiving, as part of the control information, a first indication that the first TCI state is further configured with a first pathloss reference signal for pathloss measurements associated with non-full duplex symbols and a second pathloss reference signal for pathloss measurements associated with full duplex symbols.
Aspect 3: The method of any of aspects 1 through 2, wherein receiving the indication of the duplex type comprises: receiving, as part of a control message, a first indication for the UE to use the first TCI state for uplink messages scheduled during full duplex symbols, wherein transmitting the uplink message during one or more symbols according to the second set of PC parameters of the first TCI state is based at least in part on the duplex type of the one or more symbols being full duplex.
Aspect 4: The method of aspect 3, wherein the set of TCI states comprises a second TCI state configured with at least a third set of PC parameters associated with uplink transmission in non-full duplex symbols, the method further comprising: receiving, as part of the control message, a second indication for the UE to use the second TCI state for uplink messages scheduled during non-full duplex symbols; and transmitting a second uplink message during one or more second symbols according to the second TCI state, wherein the second uplink message is transmitted according to the third set of PC parameters based at least in part on the one or more second symbols being non-full duplex.
Aspect 5: The method of any of aspects 3 through 4, wherein the control message is a MAC-CE command comprising a bitfield that indicates that the first TCI state is associated with full duplex symbols.
Aspect 6: The method of any of aspects 3 through 5, wherein the control message is a DCI message comprising a duplex field indicator that indicates that the first TCI state is associated with full duplex symbols.
Aspect 7: The method of any of aspects 1 through 6, wherein the set of TCI states comprises a third TCI state configured with a fourth set of PC parameters associated with uplink transmission in non-full duplex symbols and a fifth set of PC parameters associated with uplink transmission in full duplex symbols, the method further comprising: receiving, as part of the indication of the duplex type for the one or more TCI states of the set of TCI states, that the third TCI state is associated with both full-duplex symbols and non-full-duplex symbols; transmitting a second uplink message during one or more non-full duplex symbols according to the third TCI state, wherein the second uplink message is transmitted according to the fourth set of PC parameters based at least in part on the second uplink message being scheduled during the one or more non-full duplex symbols; and transmitting a third uplink message during one or more full duplex symbols according to the third TCI state, wherein the third uplink message is transmitted according to the fifth set of PC parameters based at least in part on the second uplink message being scheduled during the one or more full duplex symbols.
Aspect 8: The method of any of aspects 1 through 7, wherein the first set of PC parameters comprise a respective first closed-loop power index and a respective first set of open-loop parameters for each of a set of sounding reference signals and uplink channels, and the second set of PC parameters comprise the respective first closed-loop power index and a respective second set of open-loop parameters that are different than the respective first set of open-loop parameters for each of the set of sounding reference signals and uplink channels.
Aspect 9: The method of aspect 8, wherein each respective second set of open-loop parameters comprises a set of power offset values relative to a corresponding respective first set of open-loop parameters.
Aspect 10: The method of any of aspects 1 through 9, wherein the first set of PC parameters comprise a respective first set of open-loop parameters and a respective first closed-loop power index for each of a set of sounding reference signals and uplink channels, and the second set of PC parameters comprise the respective first set of open-loop parameters and a respective second closed-loop power index that is different than the respective first closed-loop power index for each of the set of sounding reference signals and uplink channels.
Aspect 11: The method of any of aspects 1 through 10, further comprising: receiving a configuration of a first default set of PC parameters associated with uplink transmission in non-full duplex symbols and a second default set of PC parameters associated with uplink transmission in full duplex symbols; receiving, as part of the indication of the duplex type for the one or more TCI states of the set of TCI states, an indication that that a fourth TCI state is associated with full duplex symbols, wherein the fourth TCI state is not configured with any set of PC parameters; and transmitting a second uplink message according to a fourth TCI state, wherein the second uplink message is transmitted according to the second default set of PC parameters based at least in part on the duplex type of the fourth TCI state being full duplex and the fourth TCI state not being configured with any set of PC parameters.
Aspect 12: The method of any of aspects 1 through 11, further comprising: transmitting a capability message that indicates that the UE supports multiple PC parameter sets associated with different symbol duplex types for a single TCI state, wherein receiving the control information is based at least in part on transmitting the capability message.
Aspect 13: The method of any of aspects 1 through 12, wherein the set of TCI states comprises a set of joint uplink and downlink TCI states or a set of uplink-only TCI states.
Aspect 14: The method of any of aspects 1 through 13, wherein a second TCI state of the set of TCI states is associated with a single set of PC parameters for uplink transmissions by the UE during non-duplex symbols and during full duplex symbols.
Aspect 15: A UE for wireless communications, comprising one or more memories storing processor-executable code, and one or more processors coupled with the one or more memories and individually or collectively operable to execute the code to cause the UE to perform a method of any of aspects 1 through 14.
Aspect 16: A UE for wireless communications, comprising at least one means for performing a method of any of aspects 1 through 14.
Aspect 17: A non-transitory computer-readable medium storing code for wireless communications, the code comprising instructions executable by one or more processors to perform a method of any of aspects 1 through 14.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control information that indicates a set of transmission configuration indicator (TCI) states, wherein a first TCI state of the set of TCI states is configured with a first set of power control parameters associated with uplink transmission in non-full duplex symbols and a second set of power control parameters associated with uplink transmission in full duplex symbols;
receive an indication of a duplex type for one or more TCI states of the set of TCI states; and
transmit an uplink message according to the first TCI state,
wherein the uplink message is transmitted according to the second set of power control parameters based at least in part on the duplex type of the first TCI state being full duplex.

2. The UE of claim 1, wherein the one or more processors are individually or collectively further operable to execute the code to cause the UE to:
receive, as part of the control information, a first indication that the first TCI state is further configured with a first pathloss reference signal for pathloss measurements associated with non-full duplex symbols and a second pathloss reference signal for pathloss measurements associated with full duplex symbols.

3. The UE of claim 1, wherein, to receive the indication of the duplex type, the one or more processors are individually or collectively operable to execute the code to cause the UE to:
receive, as part of a control message, a first indication for the UE to use the first TCI state for uplink messages scheduled during full duplex symbols, wherein transmitting the uplink message during one or more symbols according to the second set of power control parameters of the first TCI state is based at least in part on the duplex type of the one or more symbols being full duplex.

4. The UE of claim 3, wherein the set of TCI states comprises a second TCI state configured with at least a third set of power control parameters associated with uplink transmission in non-full duplex symbols, and the one or more processors are individually or collectively further operable to execute the code to cause the UE to:
receive, as part of the control message, a second indication for the UE to use the second TCI state for uplink messages scheduled during non-full duplex symbols; and
transmit a second uplink message during one or more second symbols according to the second TCI state, wherein the second uplink message is transmitted according to the third set of power control parameters based at least in part on the one or more second symbols being non-full duplex.

5. The UE of claim 3, wherein the control message is a medium access control-control element (MAC-CE) command comprising a bitfield that indicates that the first TCI state is associated with full duplex symbols.

6. The UE of claim 3, wherein the control message is a downlink control information (DCI) message comprising a duplex field indicator that indicates that the first TCI state is associated with full duplex symbols.

7. The UE of claim 1, wherein the set of TCI states comprises a third TCI state configured with a fourth set of power control parameters associated with uplink transmission in non-full duplex symbols and a fifth set of power control parameters associated with uplink transmission in full duplex symbols, and the one or more processors are individually or collectively further operable to execute the code to cause the UE to:
receive, as part of the indication of the duplex type for the one or more TCI states of the set of TCI states, that the third TCI state is associated with both full duplex symbols and non-full duplex symbols;
transmit a second uplink message during one or more non-full duplex symbols according to the third TCI state, wherein the second uplink message is transmitted according to the fourth set of power control parameters based at least in part on the second uplink message being scheduled during the one or more non-full duplex symbols; and
transmit a third uplink message during one or more full duplex symbols according to the third TCI state, wherein the third uplink message is transmitted according to the fifth set of power control parameters based at least in part on the second uplink message being scheduled during the one or more full duplex symbols.

8. The UE of claim 1, wherein:
the first set of power control parameters comprise a respective first closed-loop power state index and a respective first set of open-loop parameters for each of a set of types of uplink signals, and
the second set of power control parameters comprise the respective first closed-loop power state index and a respective second set of open-loop parameters that are different than the respective first set of open-loop parameters for each of the set of types of uplink signals.

9. The UE of claim 8, wherein each respective second set of open-loop parameters comprises a set of power offset values relative to a corresponding respective first set of open-loop parameters.

10. The UE of claim 1, wherein:
the first set of power control parameters comprise a respective first set of open-loop parameters and a respective first closed-loop power state index for each of a set of types of uplink signals, and
the second set of power control parameters comprise the respective first set of open-loop parameters and a respective second closed-loop power state index that is different than the respective first closed-loop power state index for each of the set of types of uplink signals.

11. The UE of claim 1, wherein the one or more processors are individually or collectively further operable to execute the code to cause the UE to:
receive a configuration of a first default set of power control parameters associated with uplink transmission in non-full duplex symbols and a second default set of power control parameters associated with uplink transmission in full duplex symbols;
receive, as part of the indication of the duplex type for the one or more TCI states of the set of TCI states, an indication that that a fourth TCI state is associated with full duplex symbols, wherein the fourth TCI state is not configured with any set of power control parameters; and
transmit a second uplink message according to a fourth TCI state,
wherein the second uplink message is transmitted according to the second default set of power control parameters based at least in part on the duplex type of the fourth TCI state being full duplex and the fourth TCI state not being configured with any set of power control parameters.

12. The UE of claim 1, wherein the one or more processors are individually or collectively further operable to execute the code to cause the UE to:
transmit a capability message that indicates that the UE supports multiple power control parameter sets associated with different symbol duplex types for a single TCI state, wherein receiving the control information is based at least in part on transmitting the capability message.

13. The UE of claim 1, wherein the set of TCI states comprises a set of joint uplink and downlink TCI states or a set of uplink-only TCI states.

14. The UE of claim 1, wherein a second TCI state of the set of TCI states is associated with a single set of power control parameters for uplink transmissions by the UE during non-duplex symbols and during full duplex symbols.

15. A method for wireless communications, at a user equipment (UE), comprising:
receiving control information that indicates a set of transmission configuration indicator (TCI) states, wherein a first TCI state of the set of TCI states is configured with a first set of power control parameters associated with uplink transmission in non-full duplex symbols and a second set of power control parameters associated with uplink transmission in full duplex symbols;
receiving an indication of a duplex type for one or more TCI states of the set of TCI states; and
transmitting an uplink message according to the first TCI state, wherein the uplink message is transmitted according to the second set of power control parameters based at least in part on the duplex type of the first TCI state being full duplex.

16. The method of claim 15, further comprising:
receiving, as part of the control information, a first indication that the first TCI state is further configured with a first pathloss reference signal for pathloss measurements associated with non-full duplex symbols and a second pathloss reference signal for pathloss measurements associated with full duplex symbols.

17. The method of claim 15, wherein receiving the indication of the duplex type comprises:
receiving, as part of a control message, a first indication for the UE to use the first TCI state for uplink messages scheduled during full duplex symbols, wherein transmitting the uplink message during one or more symbols according to the second set of power control parameters of the first TCI state is based at least in part on the duplex type of the one or more symbols being full duplex.

18. The method of claim 17, wherein the set of TCI states comprises a second TCI state configured with at least a third set of power control parameters associated with uplink transmission in non-full duplex symbols, the method further comprising:
receiving, as part of the control message, a second indication for the UE to use the second TCI state for uplink messages scheduled during non-full duplex symbols; and
transmitting a second uplink message during one or more second symbols according to the second TCI state, wherein the second uplink message is transmitted according to the third set of power control parameters based at least in part on the one or more second symbols being non-full duplex.

19. The method of claim 17, wherein the control message is a medium access control-control element (MAC-CE) command comprising a bitfield that indicates that the first TCI state is associated with full duplex symbols.

20. A non-transitory computer-readable medium storing code for wireless communications, the code comprising instructions executable by one or more processors to:
receive control information that indicates a set of transmission configuration indicator (TCI) states, wherein a first TCI state of the set of TCI states is configured with a first set of power control parameters associated with uplink transmission in non-full duplex symbols and a second set of power control parameters associated with uplink transmission in full duplex symbols;
receive an indication of a duplex type for one or more TCI states of the set of TCI states; and
transmit an uplink message according to the first TCI state, wherein the uplink message is transmitted according to the second set of power control parameters based at least in part on the duplex type of the first TCI state being full duplex.
